(19) United States
(12) Patent Application Publication
(10) Pub. No.: US 2006/0140822 A1
(43) Pub. Date: Jun. 29, 2006

(54) Device for thermostatting of a measuring cell

(75) Inventors: Franz Josef Krysl, Graz (AT); Wolfgang Huber, Lannach (AT); Friedrich Schneider, Buch (AT)

Correspondence Address: Roche Diagnostics Corporation, Inc., 9115 Hague Road, PO Box 50457, Indianapolis, IN, 46250-0457, US

(73) Assignee: Roche Diagnostics Operations, Inc., Indianapolis, IN (US)

(21) Appl. No.: 11/312,875

(22) Filed: Dec. 20, 2005

(30) Foreign Application Priority Data
Dec. 23, 2004 (AT) A 2158/2004

(51) Int. Cl. B01J 19/00

(52) U.S. Cl. 422/108

(57) ABSTRACT

Devices for thermostatting a measuring cell in an analyzer and measuring cells are disclosed. In one embodiment, a device is provided comprising a measuring cell with a measuring channel, wherein at least one sensor element is located in the measuring channel, and an analyzer comprising a thermostatted supporting surface. The measuring cell can be inserted into the analyzer in an exchangeable manner and can be brought into contact with the thermostatted supporting surface at least in a contact area, the measuring cell having an essentially planar measuring cell wall at least in this contact area. For rapid, reproducible temperature control of the media and sensor elements contained in the measuring cell a heat-conductive, elastic or plastic layer is provided, which will adhere at least in the contact area to at least one measuring cell wall or to the thermostatted supporting surface of the analyzer and which can be removed, essentially without residue, from the opposing thermostatted supporting surface or the measuring cell wall when the measuring cell is exchanged.

### BACKGROUND OF THE INVENTION

The present invention relates to medical analyzers and, in particular, to a device for temperature control or thermostatting of a measuring cell in an analyzer.

It is known that many devices and apparatuses containing sensors show temperature-dependent signal characteristics. Depending on the type of sensor, this effect is due to the temperature dependence of chemical processes, their equilibrium state and/or their kinetics, or, especially in the case of electrochemical sensors, a temperature-dependent change of physical properties, such as electrical conductivity.

Such sensors are frequently used in medical analyzers for the determination of gas partial pressures in blood or for the measurement of the pH-value or ion or metabolite concentrations in body fluids. In particular, such sensors are used in blood gas analyzers, which play an important role in medical diagnostics.

While the temperature coefficients of the sensors may easily be obtained by calibration measurements, a problem arises when the variables to be measured are temperature-dependent, as for instance the partial pressures and pH of blood gases (pO₂, pCO₂, pH), and when the temperature coefficients of the sample required for computational correction are not known with sufficient accuracy. Computing the values of a blood sample at body temperature (37° C.) from measurement values which have been obtained at ambient temperature will thus be prone to error.

To avoid the temperature-dependent effects mentioned above, it is known to use measuring cells with sensors in controlled temperature environments, i.e., in thermostats. If the measuring cells are to be exchanged after a certain time of use, however, the measuring cell should be easily detachable from the thermostat, which is a fixed component of the analyzer.

In general, the measuring cells are operated in a temperature-controlled chamber of the analyzer, which is kept at constant temperature and usually made from a metal alloy or ceramic material.

Especially in the case of dissolved gases the temperature of the sample during measurement plays an important role. The solubility of gases, e.g. in aqueous media, decreases as temperature increases, and the dissolved gas thus shows a tendency to escape from the solution. The measured value will thus be higher. At lower measuring temperatures a lower measurement value will be obtained.

The analysis of blood gas parameters plays an important part in medical diagnosis, especially in an emergency situation. The collective term of blood gas parameters is used for the value of oxygen partial pressure, carbon dioxide partial pressure (gas dissolved in a physiological sample) and the pH-value of the physiological sample or of an aqueous reference solution.

To obtain an accurate picture of the situation in the body of a patient measurements are carried out at a sample temperature of 37° C. Even if the time span between sample-taking and measurement is small, the blood sample will have significantly cooled off and must very quickly be heated again to body temperature in the analyzer.

The sensors used in the measuring cell are constantly kept at measuring temperature, in this case at 37° C. This is necessary since the massive heating block (large weight) has a very slow reaction to temperature change, and the measuring cell—due to being made from polymeric materials (see EP 1 087 224 A2, for example), which conduct heat poorly or very poorly—will also exhibit a sluggish reaction to temperature change. The thermostatted parts of the housing are made of polycarbonate, for instance, and have wall thicknesses of up to 5 mm, which will also increase heat transfer resistance.

Even if the measuring cell is pressed against one or more thermostatted surfaces of the analyzer, contact with the thermostatted surface is established only at a few points and in a non-reproducible manner. From EP 1 367 392 A1 an analyzer is known in this context, whose temperature controlled measuring cell is provided with electrochemical electrodes not further specified. The measuring cell is thermostatted by Peltier elements, with a flat heat-conducting distributing element being placed between the Peltier elements and the wall of the measuring cell. Due to unavoidable air gaps this arrangement will be equivalent to an air bath, with heat transfer being limited primarily by the thickness of the polymeric material around the electrochemical sensor, which is a poor heat conductor, and by the remaining air gap adjacent to the thermostatted surface.

A consequence of this set-up is a retarded change of temperature of both sample and sensor. It will thus take longer for the device to be ready for measurement at the target temperature. To shorten this delay in actual operation the sample is heated approximately to target temperature in a preheating section preceding the measuring cell. The desired temperature of samples and sensors at the measurement location is thus achieved more easily and quickly.

Some sensors contain constituents whose useful lifetime is limited by the operating temperatures required, such as for instance enzymes which enable necessary sensor reactions at the measurement site. Once these enzymes are partly or totally destroyed by prolonged temperature exposure, i.e., their activity is reduced or deactivated, the sensor can no longer be used. Higher temperatures will thus usually shorten the useful lifetime of enzyme-containing sensors.

### SUMMARY OF THE INVENTION

It is against the above background that the present invention provides certain unobvious advantages and advancements over the prior art. In particular, the inventors have recognized a need for improvements in a device for thermostatting a measuring cell for insertion in an analyzer. The device, as described herein, if possible without use of a preheating section, is suitable for quick, reproducible thermostatting of the sensors contained in a measuring cell, of the calibrating media, the reference media and the sample, and which ensures an easy and simple exchange of the measuring cell in case of malfunction or at the end of its service life.

In accordance with one embodiment of the present invention, a device for thermostatting a measuring cell in an analyzer is provided, comprising a measuring cell comprising a measuring channel, wherein at least one sensor element is located in the measuring channel; and an analyzer comprising a thermostatted supporting surface, wherein the measuring cell can be inserted in the analyzer in an exchangeable manner and will contact the thermostatted supporting surface at least in a contact area, and the measuring cell has an essentially planar measuring cell wall at least in the contact area.

The inventors have recognized that to improve heat transfer to the measuring cell by means of a heat-conductive, elastic or plastic layer, which adheres at least in the area of contact to at least one wall of the measuring cell or to the thermostatted supporting surface of the analyzer and which can be removed from the measuring cell wall or the opposing thermostatted supporting surface without residue, when the measuring cell is exchanged, and/or by proposing that the measuring cell wall, which carries at least one sensor element on its interior side facing the measuring channel, be made of a heat-conductive metal or metal alloy at least in the area of contact with the thermostatted supporting surface of the analyzer.

These embodiments of the invention (heat-conductive layer or metallic wall of the measuring cell), which can also be applied in combination, will ensure that the heat transfer resistance between the heat source, i.e., the thermostatted supporting surface of the analyzer, and the sensor or sample plane is substantially minimized. A failing measuring cell or a measuring cell that has reached the end of its useful life may be replaced by a new measuring cell without problems and without change of the prevailing thermal conditions.

In a variant of the invention the measuring cell may have two or more planar walls, which are in contact with a thermostatted supporting surface of the analyzer, a heat-conductive, elastic or plastic layer being interposed, which adheres at least in the area of contact to at least one wall of the measuring cell or to the thermostatted supporting surface of the analyzer, and which can be removed from the measuring cell wall or the opposing thermostatted supporting surface without residue, when the measuring cell is replaced.

In the case of a metal wall of the measuring cell, which is made for instance of copper or aluminium, the wall of the measuring cell may be very thin on account of the high strength of metallic materials, e.g., it could have the shape of a platelet with a thickness of typically less than about 2,000 μm, even more typically not more than about 1,000 μm. By making the metal wall very thin its heat capacity will also be minimized, thus permitting the desired temperature of the measuring cell to be attained faster.

If electrochemical sensors are used, the electrically conducting structures can of course not be applied directly to a metal platelet. To avoid short circuits in the case of a metal or metal-alloy wall the at least one electrochemical sensor is placed on the planar wall of the measuring cell facing into the measuring channel, an intermediate layer, which is electrically insulating, being interposed. As an electrically insulating medium a very thin, electrically non-conductive layer, typically less than about 100 μm, and more typically less than about 10 μm thick, is applied on the metal or metal-alloy wall of the measuring cell. This layer may be formed by a thin film, e.g. of a polymeric material, which is applied by laminating or coating techniques.

Examples of electrically non-conductive plastic layers are for instance plastic films of polycarbonate, polyester or polyvinylchloride, which are bonded to the metal platelet, or coatings of polycarbonate and polyester varnishes, which are applied to the metal platelet.

In the case of sensor types which are not based on electrochemical technology and/or do not require electrical leads, in accordance with another embodiment of the present invention, the measuring cell wall, on whose interior side facing the measuring channel the at least one sensor element is located, is made of a heat-conductive metal or metal alloy at least in the area of contact with the thermostatted supporting surface of the analyzer. Sensors of this type are for instance sensors based on optical technologies or on the determination of intrinsic properties of the sample fluid, e.g. its electrical conductivity, since such sensors must also be operated under exactly defined temperature conditions, if highly accurate and reproducible analyte measurements are required.

Since it is typical for rapid and reproducible thermo-staffing to quickly establish the required operating temperature not only in the media introduced into the measuring cell, such as calibrating media, test media or the sample fluids, but also in the sensors contained in the measuring cell, the configuration according to the invention is advantageous as it makes possible particularly fast and reproducible heat transfer to the sensors. In particular, the configuration according to the invention is advantageous as compared with configurations in which a metal layer for heat transfer is applied to the measuring cell wall opposite the sensors, since the limited heat conductivity of the medium between measuring cell wall and sensors will cause slower thermostatting of the sensors. Due to the fact that different media present in the measuring cell, for instance diverse calibrating media, test media or sample fluids, have different heat conductivities, the heat transfer is not exactly reproducible in such configurations. This will be the case especially with gaseous calibrating media, which can for instance be used with sensors for the determination of gaseous analytes such as oxygen. In contrast to this, in the configuration according to the invention heat transfer between the thermostatted supporting surface of the analyzer and the sensors will advantageously occur through defined layers whose heat conductivities are fully known.

Measuring cell walls on whose interior side facing the measuring channel the at least one sensor element is placed and which consist of a heat-conductive metal or metal alloy at least in the region of contact with the thermostatted supporting surface of the analyzer, are not required by the present invention to be configured as continuous metal layers. The present invention also comprises embodiments in which the metal layer has openings in certain regions, for instance in the shape of holes or grid-structures. Such configurations are of particular advantage if optical sensor technologies are used, since such openings in the metal layer, especially if confined to a small part of the area of the metal layer, permit the irradiation of light onto the sensors or the recording of light emitted by the sensors, without substantially impairing the heat transfer to the sensors and into the measuring channel as proposed by the invention. Optical sensor technologies of this kind are for instance described in “Fluorescent optical sensors for critical care analysis” by J. K. Tusa, M. P. Leiner; Ann Biol Clin 2003, 61:183-191. With electrochemical sensor technologies such metal layers with openings of certain shapes may also be advantageously used since contacting the sensors through these openings in the metal layer is possible. It is of course necessary to provide for suitable electrical insulation of the individual parts, for instance by an air gap between metal layer and the electrical lead of the sensor or by applying an insulating layer on the surface of the metal layer in the area of the openings or on the electrical lead of the sensor.

Interposing an intermediate layer between a measuring cell wall consisting of metal or a metal alloy and the measuring channel, or rather the sensors facing the measuring channel, may be of advantage not only for electrochemical sensors, but for all types of sensors. Such an intermediate layer may for instance serve to improve the surface characteristics of the measuring channel, e.g. the hydrophilic properties of the surface, or to improve the surface properties, in particular the adherence characteristics if further layers are to be built up, or to improve corrosion protection of the underlying metal layer, or to avoid undesirable chemical reactions between the metal layer and the fluids contained in the measuring channel.

In accordance with still another embodiment of the present invention, the device for thermostatting of a measuring cell in an analyzer or the measuring cell itself is configured in such a way that the at least one sensor element of the measuring cell is an optical sensor element and is placed on the measuring cell wall, which for instance consists of a metal or a metal alloy, with an optically transparent intermediate layer being interposed between wall and sensor element. If optical sensor technologies are used an intermediate layer between sensors and the adjacent metal layer enhancing heat transfer, may advantageously be configured as an optically transparent layer. It may furthermore be designed such that it can function as an optical fibre. Such an intermediary layer may be used in particular to feed excitation light to the sensors or conduct light emitted by the sensors to suitable detectors. Such embodiments are especially advantageous for optical procedures and assemblies, in which excitation light or emitted light is irradiated or picked up from the side, as described in EP 0 793 090 B1, for instance. Combinations of such a light-guiding intermediate layer with a metal layer, which has openings in the area of the sensors, are possible in an advantageous way, for instance if the radiation emitted by the sensors is detected in a direction normal to the direction of the irradiated excitation light.

According to yet still another embodiment of the present invention, the heat-conductive, elastic or plastic layer is furnished with a certain structure in the form of stripes, naps or the like, at least on its free surface.

In order to improve heat conduction the heat-conductive, elastic or plastic layer may contain particles of a strongly heat-conductive material, typically ceramic particles.

Furthermore, the device consisting of measuring cell, heating or cooling element of the analyzer or of its thermostatted supporting surface, may be miniaturized, such that the desired temperature is attained faster and without the need of a preheating section due to the reduced mass and dimensions.

In order to further improve heat transfer between the heat source and the sample if a heat-conductive, elastic or plastic layer is used, the essentially planar wall of the measuring cell can be made from a highly heat-conductive material, typically a ceramic material or a metal or metal alloy. Suitable materials include ceramics consisting of diverse oxides and nitrides, such as aluminium oxide, aluminium nitride, zirconium oxide, zirconium nitride, boric oxide or boron nitride etc., or metals such as copper or aluminium, etc.

In accordance with yet still another embodiment of the present invention, the measuring cell may be made up of two parts and, in the case of one-sided thermostatting, consist of a lower housing part made of strongly heat-conductive material and forming the measuring cell wall, which is planar at least in the contact area towards the thermostatted supporting surface, and of a thermally insulating upper housing part, which together with interposed sealing elements bounds the measuring channel.

Although the present invention is not limited to specific advantages or functionality, it is noted that:
The heat transfer achieved by the invention permits a rate of temperature rise of the sample in the measuring channel of approximately 5° C./s, provided the sensor is suitably designed and thermal masses are small. Due to the employed coupling technique the cooling of the sensor by a cool sample will be significantly reduced and the sensor will not require a complete warm-up phase.
If a Peltier element is chosen as the heat source for the thermostatted supporting surface, the measuring cell and the sensors contained in the cell can also be cooled. Thus, sensor systems may be kept at a cooler temperature, for example during a standby phase, and may on demand be heated to operating temperature within a few seconds.
Due to smaller thermostatted masses temperature adjustment of sensor and sample is achieved faster and energy consumption is lower.
Undesirable waiting times will be appreciably reduced, measurement values are obtained in less time, and the service life of temperature-sensitive sensors is extended.
If the total system is suitably designed, the masses to be heated will be small, and thus energy consumption will be significantly lower than in conventional systems. Due to smaller overall dimensions the surfaces to be insulated may also be kept smaller.
The reduced insulating means of the device according to the invention will occupy less space around the measuring cell. Due to reduced energy consumption the space required for energy supply (i.e., the power supply unit) will also be smaller. The amount of dissipated power will be reduced and thus the components may be packed closer together within the device. All this will be advantageous if the device is to be miniaturized.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows a device according to an embodiment of the present invention for thermostatting a measuring cell which can be inserted in an analyzer, in a sectional view normal to the flow direction of the sample;

FIGS. 2 to 4 show different variants of the device according to the invention in a sectional view as in FIG. 1;

FIG. 5 is an exploded view of the device of FIG. 4;

FIG. 6 is a sectional view of the device of FIG. 3 parallel to the flow direction of the sample;

FIG. 7 is an enlarged view of a detail of the measuring cell; and

FIG. 8 is a measurement diagram produced by a device according to an embodiment of the invention.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present invention.

### DETAILED DESCRIPTION

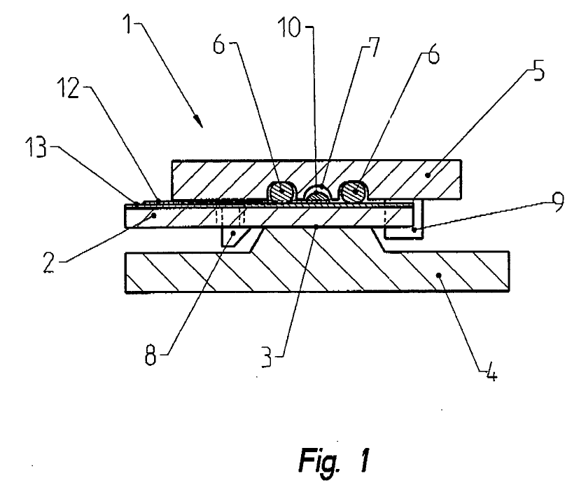

The device shown in FIG. 1 for thermostatting a measuring cell 1 which can be inserted in an analyzer (not further shown in the drawing), has at least one essentially planar measuring cell wall 2, which may be brought into contact with a thermostatted supporting surface 3 of the analyzer. The supporting surface 3 is designed for uniform transfer of thermal energy, which is provided by a heating or cooling element 4 (for instance a Peltier element). In the example shown the measuring cell 1 is configured as a two-part flow-through cell, through which the sample flows in a direction normal to the plane of the drawing. The planar measuring cell wall 2 forms the lower part of the housing and consists of highly heat-conductive material and, together with the thermally insulating upper part 5 of the housing, bounds the measuring channel 7, sealing elements 6 being interposed. The two housing parts 2, 5 are connected by means of locking elements 8, 9. In the measuring channel 7 at least one sensor element 10 is provided, e.g., an electrochemical sensor. In the example shown the planar wall 2 of the measuring cell is made of metal or a metal alloy, ensuring good heat transfer to the sensor elements 10 and the sample in the measuring channel 7. If electrochemical sensors are used the sensors themselves and their contacting leads 12 for pick-up of the sensor signals are placed on the measuring cell wall 2, an intermediate layer 13, which is electrically insulating, being interposed.

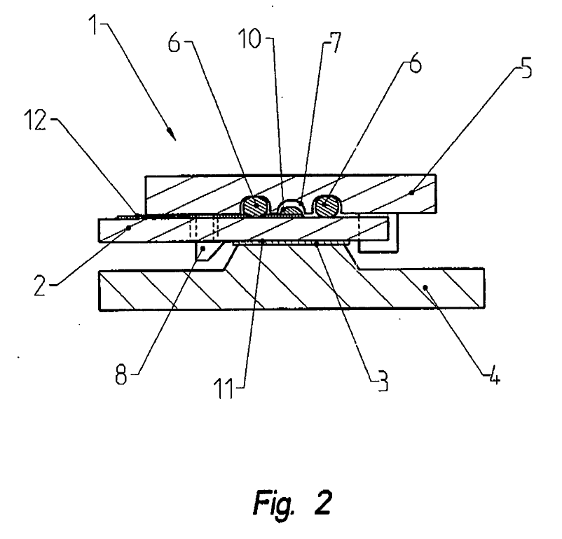

In the variant shown in FIG. 2 the planar measuring cell wall 2 is made of plastics or an electrically non-conductive inorganic material, such as ceramics, thus eliminating the necessity of an intermediate layer 13 for electrical insulation. Between the planar measuring cell wall 2 and the thermostatted supporting surface 3 of the analyzer a heat-conductive, elastic or plastic layer 11 is provided, which adheres to one of the two neighbouring surfaces 2 or 3 and may be removed without residue from the other of the two neighbouring surfaces 3 or 2, when the measuring cell is exchanged. Typically, the layer 11 is attached to the planar housing part 2, and thus will be renewed each time the measuring cell 1 is exchanged. The heat-conductive, elastic or plastic layer 11 consists typically of heat-conductive silicone material and may for example be cured in situ on the planar measuring cell wall 2 or the thermostatted supporting surface 3 of the analyzer. The heat-conductive, elastic or plastic layer 11 can be applied by means of screen printing, template printing or similar techniques.

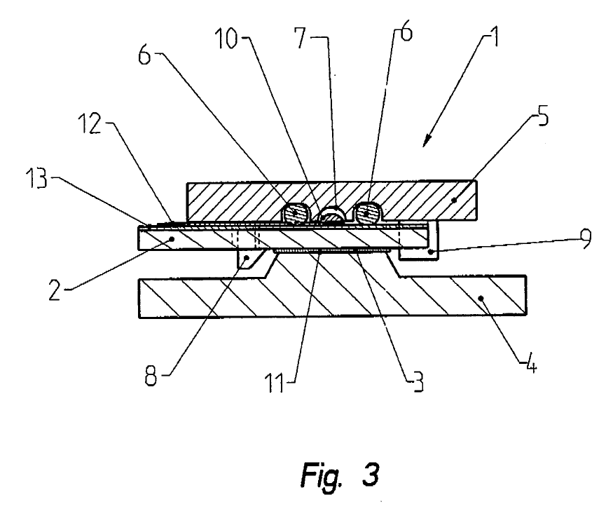

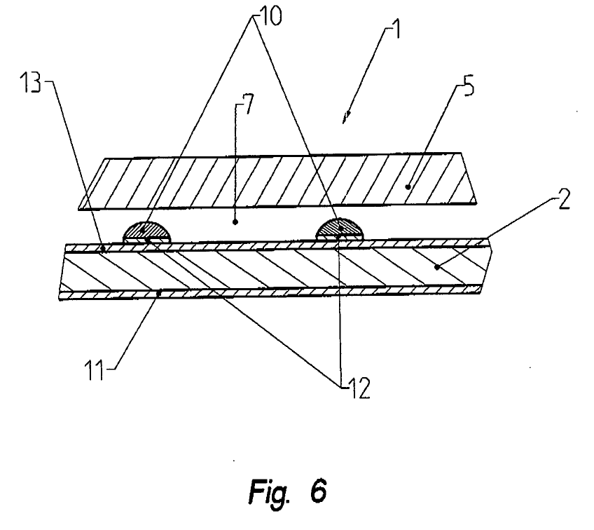

The variant shown in FIG. 3 combines the advantages of the variants of FIG. 1 and FIG. 2. Here the planar measuring cell wall 2 consists of metal or a metal alloy, a heat-conductive, elastic or plastic layer 11 being provided between the supporting surface 3 of the analyzer and the wall 2 of the measuring cell in order to further improve heat transfer. FIG. 6 is a longitudinal section through the measuring cell 1 of this variant showing the area of the sensor elements with two sensor elements 10 placed one behind the other in the measuring channel 7. The sensor elements 10 respectively their contact leads 12 (which in this case run normal to the plane of the drawing) are insulated by the intermediate layer 13, which is electrically insulating, from the measuring cell wall 2, which is made of metal or a metal alloy.

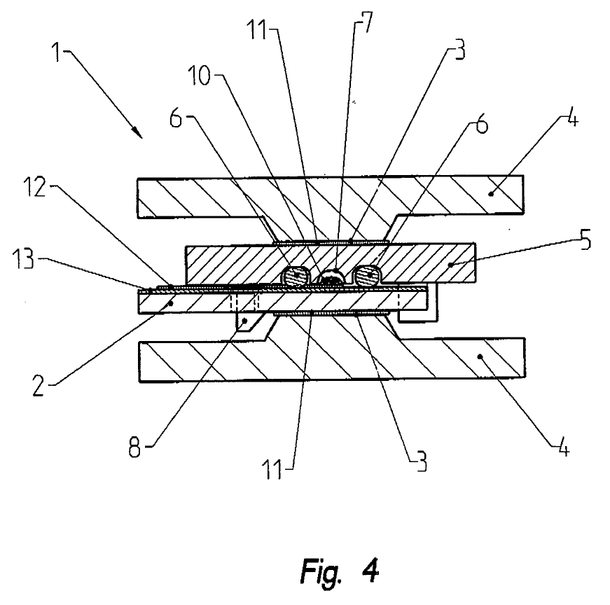

The upper part of the housing may also be configured as a planar, highly heat-conductive measuring cell wall 5, which is in contact via an intermediary heat-conductive, elastic or plastic layer 11, with a thermostatted supporting surface 3 of the analyzer, such that the measuring cell 1 is temperature controlled either only by the measuring cell wall 5 of the upper housing part or by both measuring cell walls 2 and 5, each of which—as shown in FIG. 4—is in contact with a thermostatted supporting surface 3 of the analyzer, via an intermediary heat-conductive, elastic or plastic layer 11.

In the variants of the invention shown in FIGS. 1, 3 and 4 the planar measuring cell wall 2 and/or the lower housing part adjacent to the thermostatted supporting surface of the analyzer, consists of a metal or metal alloy, thus necessitating a thin intermediate layer 13, which is electrically insulating, for the sensor element 10 and its signal lead 12. The arrangement permits direct and fast heat transfer to those regions which are essential for the sensor reactions.

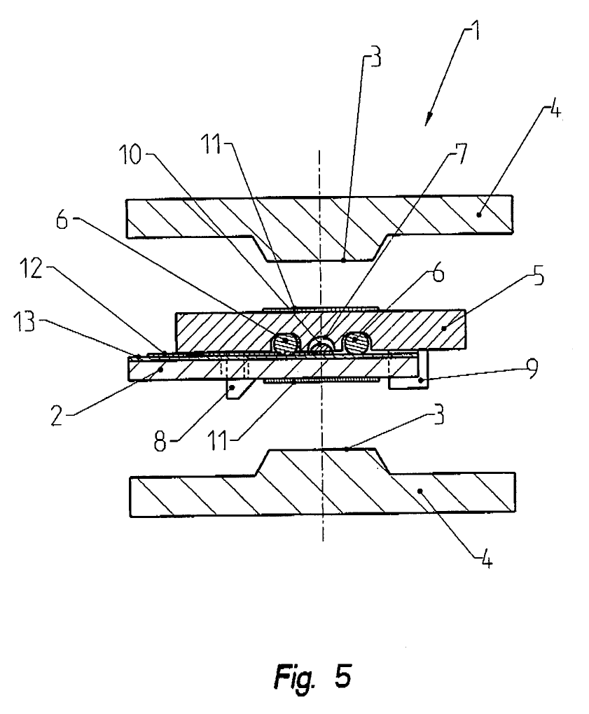

FIG. 5 shows the variant of FIG. 4 in an exploded view with heat-conductive, elastic or plastic layers 11 typically adhering to the measuring cell walls 2 and 5, which can be removed from the supporting surfaces 3 of the analyzer without residue.

The lower housing part, respectively the measuring cell wall 2, is provided with a layer of a heat-conductive silicone (e.g., Thermally Conductive RTV Silicone R-2930 of NuSil Technology CA 93013 U.S.A. or ELASTOSIL® RT 675 of Wacker Silicones, Germany) of suitable texture on one side, which is applied by laminating or coating techniques, typically by screen or template printing, and, if so required, with an electrical insulation on the other side.

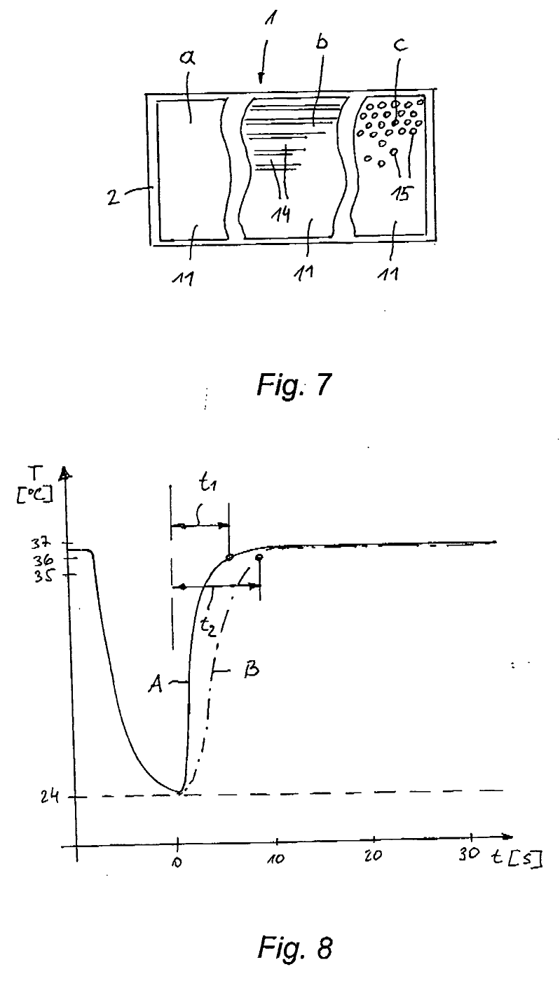

As shown in three variants in FIG. 7, in which the lower housing part 2 is viewed from above, the heat-conductive, elastic or plastic layer 11 may essentially be applied uniformly (area a) or may be provided with a suitable geometry, in particular a structure of stripes 14 (area b) or naps 15 (area c), at least on its free surface.

In the measurement diagram of FIG. 8 there is shown the adjustment time t (in s) of a measuring cell, which is to be thermostatted at a predefined temperature T (in ° C.). In order to simulate an unevenness between the thermostatted supporting surface of the analyzer and the measuring cell, a small impurity, in this case a hair, is introduced at time t=0, resulting in an adjustment time t₂ of the measured curve B, the adjustment time being defined as the time required to reach 95% of the target temperature. In the presence of the heat-conductive, elastic or plastic layer of the invention (measured curve A) the adjustment time value t₁ will be significantly smaller.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device for thermostatting a measuring cell in an analyzer, comprising:
a measuring cell comprising a measuring channel, wherein at least one sensor element is located in said measuring channel;
an analyzer comprising a thermostatted supporting surface, wherein
said measuring cell can be inserted in said analyzer in an exchangeable manner and will contact said thermostatted supporting surface at least in a contact area, and
said measuring cell has an essentially planar measuring cell wall at least in said contact area; and
a heat-conductive, elastic or plastic layer for improvement of heat transfer into said measuring cell, which elastic or plastic layer adheres, at least in said contact area, to at least one measuring cell wall or to said thermostatted supporting surface of said analyzer, and which can be removed essentially without residue from the opposing thermostatted supporting surface or the measuring cell wall when the measuring cell is exchanged.

2. The device of claim 1, wherein said heat-conductive, elastic or plastic layer is provided with a structure at least on its free surface.

3. The device of claim 2, wherein said structure comprises stripes or naps.

4. The device of claim 1, wherein said heat-conductive, elastic or plastic layer comprises a heat-conductive silicone material or ceramic particles.

5. The device of claim 1, wherein said measuring cell wall comprises a heat-conductive ceramic material.

6. The device of claim 1, wherein said heat-conductive ceramic material comprises oxides and/or nitrides selected from aluminium oxide, aluminium nitride, zirconium oxide, zirconium nitride, boric oxide, boron nitride, and combinations thereof.

7. The device of claim 1, wherein said measuring cell is provided with two or more planar measuring cell walls, which are in contact with a thermostatted supporting surface of the analyzer, a heat-conductive, elastic or plastic layer being interposed, which adheres at least in the contact area to the respective measuring cell wall or to the thermostatted supporting surface of the analyzer, and which can be removed essentially without residue from the respective opposing thermostatted supporting surface or the measuring cell wall when the measuring cell is exchanged.

8. A device for thermostatting a measuring cell in an analyzer, comprising:
a measuring cell comprising a measuring channel, wherein at least one sensor element is located in said measuring channel; and
an analyzer comprising a thermostatted supporting surface, wherein
said measuring cell can be inserted in said analyzer in an exchangeable manner and will contact the thermostatted supporting surface at least in a contact area,
said measuring cell has an essentially planar measuring cell wall at least in said contact area, and
the measuring cell wall, on whose interior side facing the measuring channel the at least one sensor element is located, is made of a heat-conductive metal or metal alloy at least in the area of contact with the thermostatted supporting surface of the analyzer.

9. The device of claim 8, wherein said measuring cell wall comprises copper or aluminium.

10. The device of claim 8, wherein said measuring cell wall has a thickness of less than about 2000 μm.

11. The device of claim 8, wherein said measuring cell wall has a thickness of less than about 1000 μm.

12. The device of claim 8, wherein said metal or metal alloy is discontinuous in said area of contact.

13. The device of claim 8, wherein the at least one sensor element is configured as an electrochemical sensor element and is placed on the measuring cell wall, with an intermediate layer, which is electrically insulating, being interposed.

14. The device of claim 13, wherein said intermediate layer has a thickness of less than about 100 μm.

15. The device of claim 13, wherein said intermediate layer has a thickness of less than about 10 μm.

16. The device of claim 13, wherein said intermediate layer comprises a polymeric material.

17. The device of claim 13, wherein said intermediate layer is applied by laminating or coating.

18. The device of claim 13, wherein said intermediate layer is a film or varnish selected from polycarbonate, polyester, polyvinylchloride, or combinations thereof.

19. The device of claim 8, wherein the at least one sensor element is configured as an optical sensor element and is placed on the measuring cell wall, with an intermediate layer, which is optically transparent, being interposed.

20. A device for thermostatting a measuring cell in an analyzer, comprising:
a measuring cell comprising a measuring channel, wherein at least one sensor element is located in said measuring channel;
an analyzer comprising a thermostatted supporting surface, wherein
said measuring cell can be inserted in said analyzer in an exchangeable manner and will contact the thermostatted supporting surface at least in a contact area, and
said measuring cell has an essentially planar measuring cell wall at least in said contact area; and
a heat-conductive, elastic or plastic layer for improvement of heat transfer into the measuring cell, which elastic or plastic layer adheres, at least in said contact area, to at least one measuring cell wall or to the thermostatted supporting surface of said analyzer, and which can be removed essentially without residue from the opposing thermostatted supporting surface or the measuring cell wall when the measuring cell is exchanged, wherein
the measuring cell wall, on whose interior side facing the measuring channel the at least one sensor element is located, is made of a heat-conductive metal or metal alloy at least in the area of contact with the thermostatted supporting surface of the analyzer.

21. A measuring cell which may be inserted in an analyzer in an exchangeable manner, with a measuring channel, in which measuring channel at least one sensor element is placed, and with a contact area towards a thermostatted supporting surface of the analyzer, said measuring cell having an essentially planar measuring cell wall at least in this contact area, wherein for improvement of heat transfer into the measuring cell a heat-conductive, elastic or plastic layer is provided, which adheres, at least in the contact area, to at least one measuring cell wall and which can be removed essentially without residue from the thermostatted supporting surface of the analyzer, when the measuring cell is exchanged.

22. A measuring cell which may be inserted in an analyzer in an exchangeable manner, with a measuring channel, in which measuring channel at least one sensor element is placed, and with a contact area towards a thermostatted supporting surface of the analyzer, said measuring cell having an essentially planar measuring cell wall at least in this contact area, wherein for improvement of heat transfer into the measuring cell that measuring cell wall on whose interior side facing the measuring channel the at least one sensor element is placed, is made of a heat-conductive metal or metal alloy at least in the contact area with the thermostatted supporting surface of the analyzer.

23. The measuring cell of claim 22, wherein the at least one sensor element is configured as an electrochemical sensor element and is placed on the measuring cell wall, with an intermediate layer, which is electrically insulating, being interposed.

24. The measuring cell of claim 22, wherein the at least one sensor element is configured as an optical sensor element and is placed on the measuring cell wall, with an intermediate layer, which is optically transparent, being interposed.
